(19) United States
(12) Patent Application Publication
(10) Pub. No.: US 2026/0145271 A1
(43) Pub. Date: May 28, 2026

(54) REFLECTIVE LIGHTGUIDE DEVICE AND METHOD FOR PRODUCING THE SAME

(71) Applicant: SCHOTT AG, Mainz (DE)

(72) Inventors: Alexander Paul SUNDERMEIER, Mainz (DE); Jonas DIMROTH, Mainz (DE); Lennart STILTZ, Mainz (DE); Fabian WAGNER, Mainz (DE)

(21) Appl. No.: 19/178,188

(22) Filed: Apr. 14, 2025

(30) Foreign Application Priority Data
Apr. 22, 2024 (DE) 10 2024 111 203.4

(51) Int. Cl. B23K 26/08; B23K 26/0622; B23K 26/53; B23K 103/00; G02B 27/01

(52) U.S. Cl. CPC B23K 26/0869; B23K 26/0624; B23K 26/53; G02B 27/0172; B23K 2103/54; G02B 2027/0178

(57) ABSTRACT

A method for cutting a reflective light guide device from a light guide plate along a predefined contour is provided by directing a laser beam onto the light guide plate which enters the light guide plate on a main surface and forms a filament shaped damage along an elongated focus within the light guide plate. The laser beam is advanced relative to the light guide plate along the predefined contour so that a multitude of filament shaped damages are introduced side-by-side into the light guide plate. A section of the predefined contour extends within the part of the light guide plate in which cemented bond faces of the glass elements and the light reflecting layers are oriented obliquely to the main surfaces so that the laser beam penetrates the light reflecting layer being oriented obliquely to the laser beam. The reflective light guide device is cleaved from the light guide plate at the predefined contour.

### CROSS REFERENCE TO RELATED APPLICATIONS

This application claims the benefit of priority from German Patent Application No. 10 2024 111 203.4 filed on Apr. 22, 2024, the contents of which are incorporated herein by reference.

### FIELD OF THE INVENTION

The field of the invention generally relates to optical displays and their manufacture. More specifically, the present invention relates to optical devices which guide light internally and direct the light outside by an arrangement of internal reflecting surfaces. Such reflective lightguide devices may be used for head mounted displays. Such a display may be employed to superimpose image information of a projector to the ambient image visible to the user. Of course, displays other than head mounted displays may employ this kind of optical device and superposition of different image or information sources as well.

### BACKGROUND OF THE INVENTION

Head mounted displays with a reflective lightguide device can be used to display information coupled into the lightguide, guided along the same and then reflected towards the eye of a user. As the lightguide is transparent, the user can also observe his surrounding through the lightguide. Thus, the information coupled into the light guide may be superimposed to the image of the surrounding for augmented reality applications.

Reflective lightguide devices suitable for this or similar applications are composed of a multitude of cemented glass elements with reflective or partially reflective layers. Thus, the lightguide devices have a complex structuring and are expensive to produce. Typically, a plate shaped intermediate product with the cemented glass elements is produced and then the lightguide is cut therefrom along a predefined contour line according to the desired shape, e.g. the shape of an eyeglass lens.

However, cutting is challenging since the cemented bonds and the glass have very different mechanical characteristics and the bonds are prone to delamination in the cutting process. Thus, the cutting process may produce a certain amount of scrap which is particular detrimental as the cutting is one of the last production steps where most of the production cost have already been accumulated. Further, even a small delamination at the edge or inside of the reflective lightguide device may considerably impair the strength of the lightguide and its optical properties.

It is therefore an object of the invention to provide a more reliable cutting process and improve the mechanical and optical characteristics of the edge of a reflective lightguide device. This object is achieved by the subject matter of the independent claims. Advantageous refinements are defined in the respective dependent claims.

### SUMMARY OF THE INVENTION

To solve the aforementioned problems, a method for cutting a reflective light guide device from a light guide plate is provided, wherein
the light guide plate has two main surfaces, and
comprises a multitude of glass elements with bond faces, the glass elements being cemented together by bond layers at their bond faces, the light guide plate further comprising light reflecting layers extending along the bond faces of the glass elements cemented together, wherein
at least within a part of the light guide plate the bond faces of the glass elements and hence the light reflecting layers are oriented obliquely to the main surfaces, and wherein a reflective light guide device is cut from the light guide plate along a predefined contour by focusing and directing the laser beam of an ultrashort pulse laser onto the light guide plate so that the laser beam enters the light guide plate on one of the main surfaces and has an elongated focus so that a filament shaped damage is formed along the elongated focus within the light guide plate, and wherein
the laser beam is advanced relative to the light guide plate along the predefined contour so that a multitude of filament shaped damage are introduced side-by-side into the light guide plate so that the filament shaped damages are reproducing the predefined contour, wherein
at least a section of the predefined contour extends within the part of the light guide plate in which the cemented bond faces of the glass elements and the light reflecting layers are oriented obliquely to the main surfaces so that the laser beam penetrates the light reflecting layer being oriented obliquely to the laser beam, wherein the filament shaped damages extend on both sides of the light reflecting layer, and wherein
the reflective light guide device is separated from the light guide plate at the predefined contour weakened by the filament shaped damages by cleaving.

The separation using the method according to this disclosure provides a superior quality of the edges compared to CNC machined light guides. Compared to CNC machined edges, a very low degree of chipping is observed. Further, no or at least nearly no delamination at the bond layers between the glass elements can be achieved. Accordingly, in a second aspect a reflective light guide device is provided, preferably producible with the method according to this disclosure, the reflective light guide device being plate shaped and having two main surfaces and an edge face forming the outer contour of the reflective light guide device and extending between the main surfaces, wherein the reflective light guide device
comprises a multitude of glass elements with bond faces, the glass elements being cemented together by bond layers at their bond faces, wherein
the reflective light guide device further comprises light reflecting layers extending along the bond faces of the glass elements, wherein
at least within a part of the reflective light guide device the bond faces of the glass elements and hence the light reflecting layers are oriented obliquely to the main surfaces, and wherein at least some of the light reflecting layers that are oriented obliquely to the main surfaces terminate at the edge face of the reflective light guide device. The bonding may be achieved with organic bonding glue or inorganic bonding glue, preferably with organic bonding glue. Accordingly, preferably the glass elements are cemented together by organic bond layers. The edge face is produced by the laser filamentation process as described above. Typically, due to the process, the edge face has a surface structure with at least one of the following features:
the surface structure has an anisotropic spatial frequency spectrum, wherein the spatial frequencies in the direction vertically to the main surfaces have a lower median value than the spatial frequencies in a direction perpendicular thereto along the edge face,
the edge face has a pattern of regularly spaced elongated channel like structures extending perpendicular to the main surfaces having a lateral dimension of less than 2 μm.

The method for producing a reflective light guide device according to this disclosure also generally produces edges at the reflective light guide device having, if any, only small chippings and/or no or nearly no delamination of the bond layers. Thus according to another aspect of the invention, independent from whether the features of spaced channels or an anisotropic texture is present, a reflective light guide device is provided, the reflective light guide device being plate shaped and having two main surfaces and an edge face forming the outer contour of the reflective light guide device and extending between the main surfaces, wherein the reflective light guide device
comprises a multitude of glass elements with bond faces, the glass elements being cemented together by bond layers at their bond faces, wherein
the reflective light guide device further comprises light reflecting layers extending along the bond faces of the glass elements, wherein
at least within a part of the reflective light guide device the bond faces of the glass elements and hence the light reflecting layers are oriented obliquely to the main surfaces, i.e. are oriented slanted to, or inclined to, or with an angle to the main surfaces, respectively, and wherein at least some of the light reflecting layers that are oriented obliquely to the main surfaces terminate at the edge face of the reflective light guide device, the reflective light guide device having at least one of the following features:
chippings at the edge between the edge face and a main surface within the part of the reflective light guide where the bond faces of the glass elements and hence the light reflecting layers are oriented obliquely to the main surfaces in average extend into the main surface by less than 30 μm, preferably less than 10 μm,
chippings at the edge between the edge face and a main surface within the part of the reflective light guide where the bond faces of the glass elements and hence the light reflecting layers are oriented obliquely to the main surfaces in average extend along the edge face by less than 30 μm, preferably less than 10 μm,
chippings at the edge between the edge face and a main surface having a length along the edge of less than 50 μm in average.

In a preferred embodiment, the light guide device according to this disclosure forms an eyepiece.

The invention is described in the following in more detail with respect to the accompanying drawings.

### BRIEF DESCRIPTION OF THE DRAWINGS

FIG. 1 shows a perspective view of a light guide plate.

FIG. 2 shows a glass element.

FIG. 3 shows a light guide plate mounted on a support.

FIG. 4 shows a reflective light guide device cut from the light guide plate shown in FIG. 1.

FIG. 5 shows a surfaced structure of the edge face of a reflective light guide device.

FIG. 6 shows a micrograph of an edge face.

FIG. 7 shows a contour plot of the spatial frequency spectrum of the micrograph of FIG. 6.

FIG. 8 and FIG. 9 show micrographs of CNC machined edges.

FIG. 10 and FIG. 11 show micrographs of a laser machined edge.

FIG. 11, FIG. 12 and FIG. 13 show micrographs of an edge faces with cemented glass elements.

FIG. 14 shows a reflective light guide device fabricated using a varying pitch of the filament shaped damages.

### DETAILED DESCRIPTION OF THE INVENTION

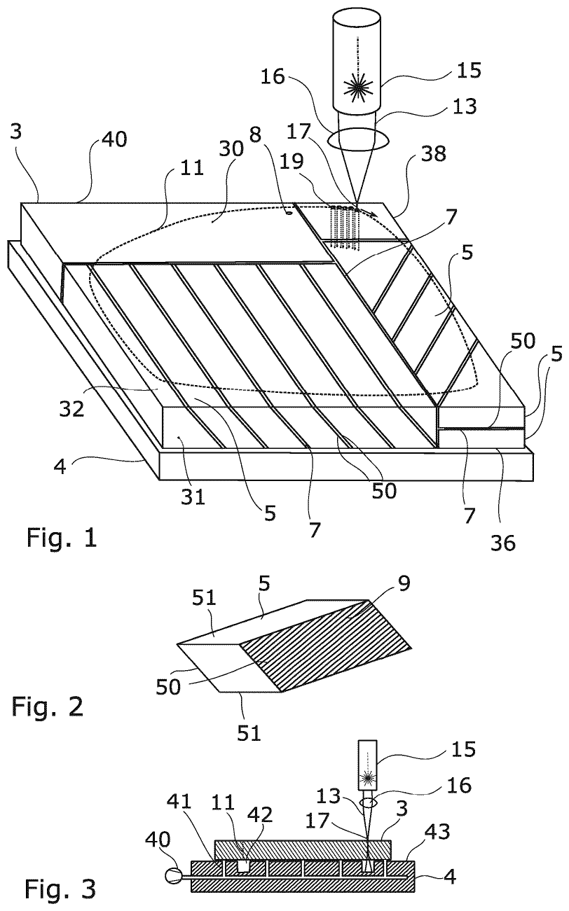

FIG. 1 shows a schematic of a light guide plate 3. The light guide plate 3 has two main surfaces 30, 31 parallel to each other. The light guide plate 3 is composed of a multitude of glass elements 5 cemented together at bond faces 50 via organic bond layers 7. For example, a UV curing adhesive may be used for the bond layers 7. In a preferred embodiment and as also shown in FIG. 1, the light guide plate 3 and also the light guide device which is cut from the light guide plate 3 are subdivided into at least two parts 32, 36, 38, 40, wherein adjacent parts have differently shaped and/or oriented glass elements 5. In part 32 the bond faces 50 of the glass elements 5 are oriented obliquely to the main surfaces 30, 31 of the light guide plate 3. Generally, there may be other parts of the light guide plate 3 where the bond faces 50 are oriented parallelly or vertically to the main surfaces. For example, the bond faces in part 36 are oriented vertically to the main surfaces 30, 31. As well, part 36 has one pair of glass elements 5 cemented together with a bond layer 7 and respective bond faces 50 oriented parallel to the main surfaces 30, 31. For example, such a bond face with a reflective layer may be used to suppress certain reflections producing ghost images. In some embodiments the light guide plate 3 may comprise one or more further optical elements, preferably a retarder element, preferably comprising a birefringent material, e.g. quartz. In some embodiments, the light guide plate 3 comprises a retarder element crossed by the predefined contour 11.

FIG. 2 shows an embodiment of a glass element 5, specifically, a glass element 5 as used in part 32. The glass element 5 has a parallelogram shaped cross section so that its bond faces 50 are oblique or inclined with respect to faces 51. As can be seen from FIG. 2, one of the bond faces 50 is provided with a light reflecting layer 9. Thus, within part 32 of light guide plate 3 the light reflecting layers 9 extend along the bond faces 50 of the glass elements 5 cemented together and are oriented inclined or obliquely to the main surfaces 30, 31. This way, in a preferred embodiment, light guided along the light guide plate 3 or the reflective light guide device cut therefrom, is reflected out of one of the main surfaces 30, 31 towards the eye of a user. The light reflecting layer 9 preferably is partially reflective so that subsequent light reflective layers 9 along the path of the light each reflect only a fraction of the guided light. In a further preferred embodiment, the light reflecting layers 9 are formed as dielectric reflection coatings or dielectric mirrors, respectively, which typically are composed of a sequence of dielectric layers with different refractive indices.

As can be seen in FIG. 1, the light guide plate 3 may comprise further parts 36, 38, 40. In a preferred embodiment, a part 36 is provided, having glass elements 5 with bond faces that are oriented vertically to the main surfaces 30, 31, but obliquely to the direction of the bond faces 50 of glass elements 5 of part 32 along the main surfaces 30, 31. This way, light guided along the plate 3 may be deflected towards part 32 by the light reflecting layers of glass elements 5 of part 36. As the light reflecting layers 9 of part 36 may preferably partially reflective similar to those of part 32, the light beam is expanded to a multitude of spatially distributed rays. A further part 38 may comprise a mirror layer oriented obliquely, or, respectively, slanted to the main surfaces 30, 31 to deflect a light beam which enters the light guide plate 3 via one of the main surfaces into a direction along the plate 3 towards the light reflecting layers of part 36.

Finally, one or more parts 40 may be provided formed by single glass elements 5 or massive glass blocks.

As shown in FIG. 1, the light guide plate 3 is cut along a predefined contour 11, shown as a dashed line to produce a reflective light guide device. Cutting is performed by focusing and directing the laser beam 13 of an ultrashort pulse laser 15 onto the light guide plate 3 so that the laser beam 13 is formed into an elongated focus 17 and enters the light guide plate 3 on one of the main surfaces 30, 31. As shown and as preferred, the elongated focus 17 already starts above the light guide plate 3 and extends into the same. In this regard, the elongated focus 17 is referred to as the section along the laser beam, within which the light intensity exceeds 75% of the maximum intensity reached by focusing of the beam. According to one example, the optical system is adjusted so that the focus has an offset of −1.95 mm, i.e. starts 1.95 mm below the main surface 30 of the light guide plate 3. Such an offset in the range of 1.5 to 2.5 mm generally is suitable for a thickness of the light guide plate 3 in the range from 1 mm to 3 mm, e.g. for a thickness of 1.55 mm. In another embodiment, the optical system may be adjusted so that the focal line starts above the main surface. This way, the focal line may extend along the whole thickness of the light guide plate 3.

Due to the high intensity of the pulsed and focused laser beam, nonlinear optical processes such as optical breakdown occur, resulting in the formation of a filament shaped damage 19 along the elongated focus 17 within the light guide plate 3. Typically, the filament shaped damage 19 are formed as thin channels within the glass. As shown, the laser beam 13 is advanced relative to the light guide plate 3 along the predefined contour 11 so that a multitude of filament shaped damages 19 are introduced side-by-side into the light guide plate 3. In the example shown, the laser beam 13 is moved along the contour 11 in a clockwise direction, as indicated by an arrow. This way, after moving along the whole contour 11, the filament shaped damages 19 are reproducing the predefined contour 11 and define a breaking line. In another embodiment, the laser beam may be moved along the contour 11 counterclockwise. The movement in clockwise or counterclockwise rotation may have an influence on the surface properties of the cut element along the part with the obliquely oriented bond faces 50.

To provide the relative movement along the contour 11, the laser optics or the light guide plate 3, or both may be moved with appropriate means such as a x-y-stage. The light guide plate 3 is preferably mounted on a support 4 which may, e.g., be a vacuum chuck.

An elongated focus 17 may be generated in various ways. It is known to employ a so called axicon which basically is a conical prism and which forms a Bessel-like beam. However, for the method according to this disclosure, a lens 16 with a high spherical aberration is preferred as the lens can be more easily adjusted. Further, an aspherical lens with elongated focus may be more preferred due to the more homogeneous intensity distribution. The elongate focus 17 preferably has a length of at least 0.5 mm, preferably a length of between 0.75 mm and 6 mm. This length also characterizes the spherical aberration of the lens 16. Preferably, the optical system is designed to provide an elongated focus 17 having a length exceeding the thickness of the light guide plate 3 or the reflective light guide device 1. Typically, the reflective light guide device 1 has a thickness within a range from 0.5 mm to 5.5 mm, preferably from 0.75 mm to 2.5 mm. In one example, the thickness is 1.2 mm.

The predefined contour 11 also crosses part 32. Hence, a section of the predefined contour 11 extends within the part 32 of the light guide plate 3 in which the cemented bond faces 50 of the glass elements 5 and the light reflecting layers 9 are oriented slanted or obliquely to the main surfaces 30, 31. However, the laser beam 13 penetrates the light reflecting layers 9 without being considerably deflected so that the filament shaped damages 19 extend on both sides of the respective light reflecting layer 9.

In a preferred embodiment, this can be achieved by providing light reflecting layers having a higher reflectance in the visible wavelength range between 750 nm and 450 nm compared to the wavelength of the laser beam, the wavelength of the laser beam 13 being within an infrared wavelength range from 900 nm to 1200 nm. This may be achieved by providing light reflecting layers 9 being formed as dielectric multilayer coatings. In other words, the light reflecting layers are dichroic, having a high reflectivity in the visible range and are highly transparent in the infrared wavelength range. This way, the light reflective layers 9 do not substantially deflect the laser beam.

Otherwise, the laser beam 13 would be deflected in a direction along the main surfaces 30, 31 so that the filament could not completely penetrate the light guide plate 3 with full intensity. In an alternative or additional definition of this feature, the method may comprise using a laser beam 13 having a wavelength for which the reflectance at the interface between adjacent glass elements 5 being less than 5%, the interface being formed by the bond faces 50 with the intermediate organic bond layer 7 and the light reflecting layer 9. Preferably, the ultrashort pulse laser 15 is operated at a wavelength in a range from 1000 nm to 1200 nm, more preferred in a range from 1050 nm to 1070 nm.

After the filament shaped damages are introduced along the predefined contour 11 weakened by the filament shaped damages 19, the reflective light guide device 1 may be separated from the plate 3 by cleaving. This may be achieved by introducing thermomechanical stress at the weakened contour 11, e.g. using a laser or hot air or gas as heat source. Or, the separation may be accomplished by mechanical stress such as a bending force. This embodiment is advantageous to avoid deterioration of the organic bond layers 7 due to applied heat. To facilitate cleaving, also, additional lines of filament shaped damages may be introduced, extending from the contour 11 to the edge of the light guide plate 3.

The ultrashort pulse laser 15 may also be used to apply one or more fiducial marks 8. These fiducial marks 8 may be used later to adjust the position of the reflecting light guide device, e.g. the orientation of the light guide device used as an eyepiece with respect to the user's eye. According to one embodiment, one or more fiducial marks 8 are engraved by ablation using the ultrashort pulse laser 15. For example, a further lens 16 may be used having a shorter focal length so that the pulse energy is deposited at the main surface 30.

Generally, the orientation of the predefined contour 11 and/or the one or more additional fiducial marks 8 may be determined according to internal or external features of the light guide plate. These features may include the interfaces between glass elements 5, or, respectively, the organic bond layers 7 or light reflecting layers 9. As well, the outer contour or sections thereof may define features suitable to determine the orientation of the predefined contour on the light guide plate 3.

Thus, according to one embodiment of the method, the following steps are executed:
a light guide plate 3 is provided and fixed on a support 4,
the light guide plate 3 fixed on the support 4 is aligned relative to the ultrashort pulse laser 15 based on at least one feature of the light guide plate 3, the feature includes at least one of: the interface between two glass elements 5 cemented together, a light reflecting layer 9, an edge of the light guide plate,
the light guide plate 3 is moved relative to the ultrashort pulse laser 15 until a predefined position for a fiducial mark 8 is reached and the fiducial mark 8 is introduced by ablation using the ultrashort pulse laser 15,
the light guide plate 3 and the ultrashort pulse laser 15 are moved relative to each other so that the laser beam 13 moves along the predefined contour 11 and introduces a series of filament shaped damages 19 on the contour 11,
the light guide plate 3 is cleaved at the predefined contour 11 weakened by the filament shaped damages 19 so as to obtain the reflective light guide device having the desired shape.

As the focus 17 is preferably longer than the thickness of the light guide plate 3, the laser beam may not only introduce a filament shaped damage to the plate 3, but may also damage or ablate the support holding the light guide plate. This in turn may also damage or contaminate the light guide plate 3. To avoid this, a support 4 for fixing the light guide plate 3 may be used having a clearance extending along the predefined contour 11. A schematic example is shown in FIG. 3. The support of this example is designed as a vacuum chuck having a vacuum pump 40 connected to channels 41 open out to the support face 43 so that the light guide plate 3 is sucked onto the support 4. As can be seen, an annular clearance 42 is introduced in the support face 43. This clearance is shaped according to the predefined contour 11. This way, the light guide plate 3 can be placed onto the support 4 and approximately oriented so that the predefined contour 11 lies above the clearance. Then, the light guide plate 3 may be fixed to the support by applying vacuum. The laser beam 13 exiting the light guide platen then enters into the clearance 42. To avoid ablation or other damage, the bottom of the clearance 42 may be provided with a suitable absorbing material. Other than depicted, the clearance 42 may also be provided by the outer edge of the support 4. In this case, the support 4 only fixes the light guide plate 3 in the area enclosed by the predefined contour 11.

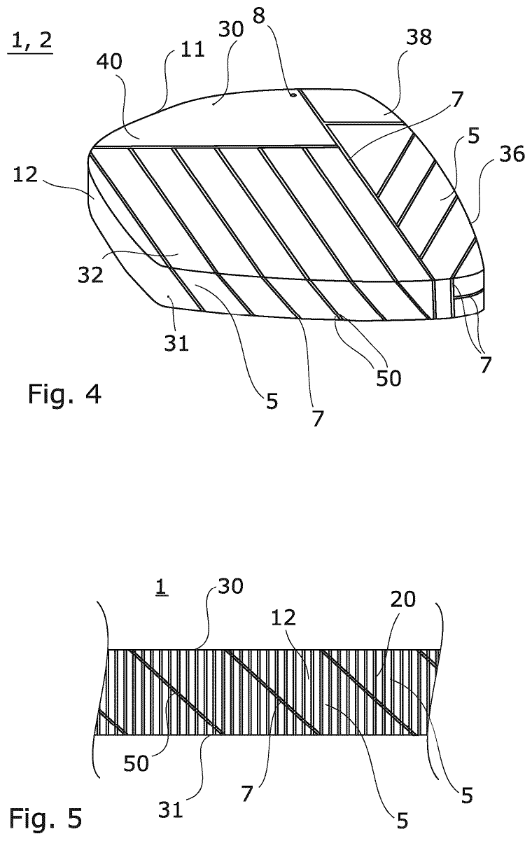

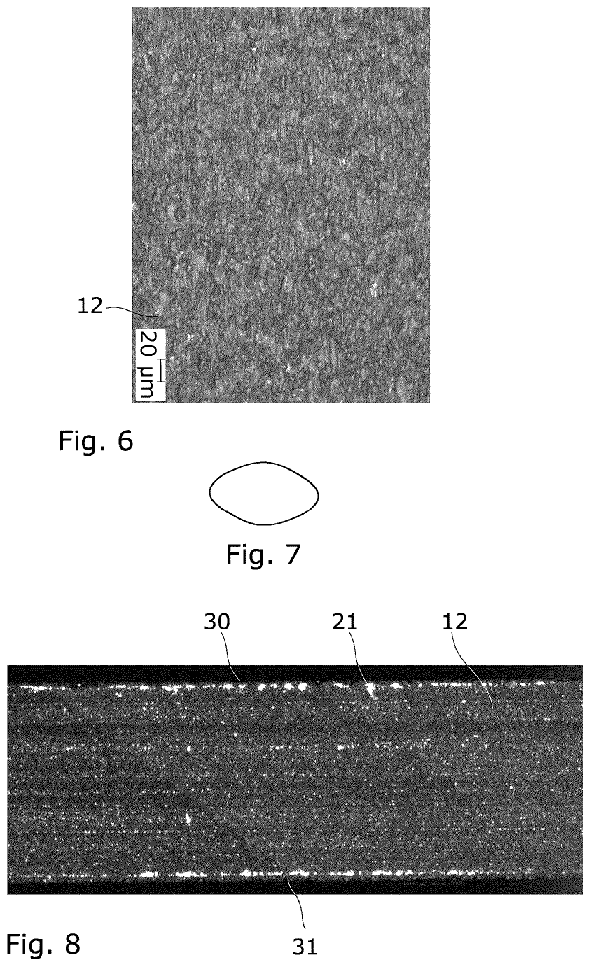

FIG. 4 shows a reflective light guide device cut from the light guide plate depicted in FIG. 1 using the ultrashort pulse laser 15 and the perforation along the contour 11 by the introduced filament shaped filaments 19. The reflective light guide device 1 is plate shaped and, like the light guide plate 3 has two main surfaces 30, 31. In particular, the reflective light guide device 1 may have a contour suitable to form an eyepiece 2. The edge face 12 forms the outer contour of the reflective light guide device 1. As the edge face 12 is produced by perforating the light guide plate 3 along the predefined contour 11 and separating the reflective light guide device 1 from the light guide plate 3 at the filament shaped damages, a specific texture of the edge face 12 is produced. According to one embodiment, the edge face 12 has a pattern of regularly spaced elongated channel or groove like structures 20 extending perpendicular to the main surfaces 30, 31 having a lateral dimension of less than 2 μm. Such a surface texture is schematically shown in FIG. 5. The section of the edge face 12 depicted in FIG. 5 extends along part 32 with the organic bond layers 7 between the glass elements 5 extending obliquely to the main surfaces 30, 31 of the reflective light guide device 1. Further, the channel like structures 20, which are the remnants of the filament shaped damages are crossing the organic bond layers 7 although at least one of the bond faces 50 is provided with a light reflecting layer. However, the depiction of FIG. 5 is idealized in that typically the channel like structures 20 are not visible along the whole distance between the main surfaces 30, 31. Further, depending on the pitch of the filament shaped damages 19, the channel like structures 20 may not even be visible on the edge face 12. This is particularly the case when a small pitch is chosen. A micrograph of such an edge face 12 is shown in FIG. 6. The orientation of the edge surface 12 is the same as in the sketch of FIG. 5. Although no or hardly no channel like structures are visible, the surface structure nevertheless has an anisotropy. Specifically, the surface structure has an anisotropic spatial frequency spectrum, wherein the spatial frequencies in the direction vertically to the main surfaces 30, 31 (which is the vertical direction of the micrograph) have a lower median value than the spatial frequencies in a direction perpendicular thereto along the edge face 12 (i.e. in horizontal direction of the micrograph, or parallel to the main surfaces, respectively). This can be visualized by applying a FFT filter to the image. In some cases, the filaments may be visible at the edge. In this case, an even larger anisotropy results.

FIG. 7 shows a contour plot of the spatial frequency spectrum of the micrograph of FIG. 6. This contour plot is obtained by calculating the Fourier transform of the micrograph and applying a threshold to the grey values. This contour plot represents a contour of equal spatial frequencies and is rotated by 90° due to the transform. As can be clearly seen, the contour is oblong, having an aspect ratio of approximately 1.7/1, which means that the spatial dimensions of structures in the vertical and horizontal directions having the same frequency differ in their length by a factor of approximately 1.7. An anisotropic spectrum of spatial frequencies may in particular be found within a range of spatial frequencies from 10 μm to 100 μm.

In difference thereto, a CNC-machined edge has a surface texture with structures extending parallel to the main surfaces 30, 31. An example is shown in FIG. 8. The edge face 12 shows horizontal traces induced by the rotating grinding tool. Furthermore, at the edges between the main surfaces 30, 31 and the edge face 12, larger chippings 21 are visible as bright spots. The chippings 21 may reduce the mechanical strength of the reflective light guide device 1 and also may cause deflections of light rays which could be visible by a user of the reflective light guide device 1, e.g. as disturbing light flashes.

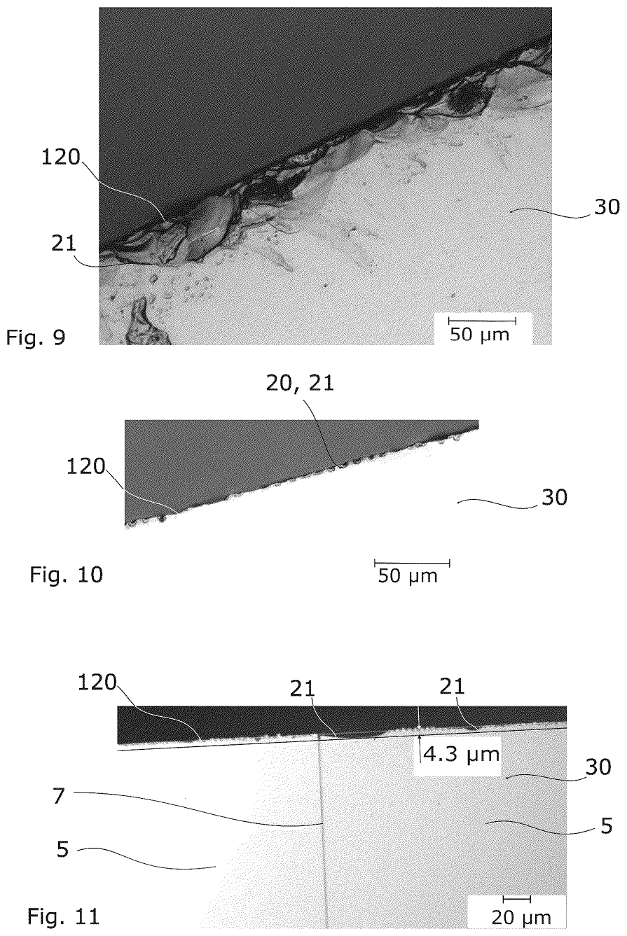

FIG. 9 shows a microscope image of a CNC machined edge in top view onto a main surface 30. The contour of the reflective light guide device shows a continuous damage with chippings 21 at the edge 120 between the main surface 30 and the edge face, extending into the main surface 31. The region with chippings 21 ends approximately 50 μm away from the edge 120, bigger chippings up to a size of approximately 150 μm can be found sporadically.

For comparison, FIG. 10 shows a micrograph of a laser machined edge, produced with the method according to this disclosure. The micrograph has a magnification similar to FIG. 9. As is evident, nearly no chippings 21 are visible. In particular, small chippings 21 regularly spaced at a pitch of approximately 10 μm can be attributed to the top of groove like structures 20 which are the remnants of the filament shaped damages introduced by the ultrashort pulse laser.

Regarding chippings, the regions close or adjacent to the organic bonding layers are particularly sensitive. FIG. 11 shows an example of chippings that occurred at the glass adjoining the organic bonding layer 7. FIG. 11 is a micrograph taken in top view onto the main surface 30. As can be seen, the larger chipping 21 extends into the main surface 30 by approximately 4.3 μm, i.e. by less than 10 μm, or even by less than 5 μm. The chipping 21 directly starts at the edge of one of the glass elements 5 and at the organic bond layer 7. In contrast to the CNC-machined edge as shown in FIG. 9, it is also evident that the remaining chippings 21 are isolated or scattered along the edge 120, whereas the CNC machined edge shows continuous and superimposed chippings 21.

In this regard it has been found out that the number of chippings can be further reduced with suitable laser parameters. To avoid or reduce chippings 21 at the interface between the glass elements 5, it is generally advantageous to use laser pulses having a pulse length of less than 50 ps, preferably less than 20 ps for introducing the filament shaped damages. Even pulse lengths in the femtosecond range, i.e. below 1 ps may be used. Generally, a preferred range of pulse lengths is from 50 fs to 50 ps. These short pulse lengths reduce thermomechanical stresses during the filamentation process, which otherwise could be useful to further weaken the breaking line. However, the short pulses not only avoid chippings near the interfaces between the glass elements 5 but also avoid a deterioration or delamination of the organic bond layers 7.

Thermomechanical stresses and microcracks may also be caused by too high a applied pulse anergy or a large number of pulses within a burst if the laser is operated in a so called burst mode. It is therefore generally preferred that the number of pulses within a burst is less than 8. Thus, according to one embodiment, the ultrashort pulse laser 15 is operated in single pulse mode or in burst mode with less than eight pulses per burst. According to one example, the laser 15 is operated with the following parameters:
pulse duration: 10 ps;
average power: 30 W;
wavelength: 1064 nm,
pulse frequency: 100 kHz;
pulses per burst: 3.

The average laser power and the pulse frequency are process parameters that are mutually dependent and are linked via the desired and permissible pulse energy, the traversing speed of the axis system and the pitch. They can differ for different pulse durations and is largely dependent on the substrate respectively the bonding layer system. When producing free form contour lines, the traversing speed of the axis system is typically varied, whereby smaller radii of the contour line are produced at a lower speed. Maintaining a locally desired pitch results in a lower average power and a lower pulse repetition frequence. The average laser power is typically in a range from 1 W to 200 W, preferably from 5 W to 100 W, more preferably in a range from 10 W to 50 W, while the pulse repetition frequency is usually in a range from 1 kHz to 300 kHz, preferably in a range from 2 kHz to 100 kHz, while the pitch is typically in a range from 3 μm to 15 μm, preferably in a range from 5 μm to 10 μm.

The laser wavelength typically is a range from 800 nm to 1200 nm, preferably from 1000 nm and 1100 nm, and typically about 1030 nm or 1064 nm.

FIG. 12 and FIG. 13 show micrographs of an edge faces with cemented glass elements. These images demonstrate that the exposure of high light intensities also may influence the interfaces of the cemented glass elements. Specifically, FIG. 12 shows an edge face 12 where chippings occur at the interfaces 52 of the cemented glass elements 5. As said, the interfaces 52 include the bond faces 50, the organic bonding layer 7 and the light reflecting layer 9. In the example of FIG. 12, the laser beam 13 entered on main surface 30 and exited on main surface 31. As can be seen, a zone of chippings 21 extend from the interface 52 in direction towards main surface 31. Thus, the chippings 21 are present at the far side of the interface 52 with respect to the direction of the laser beam. Further, the zone of chippings grows larger with increasing distance to the main surface 30, where the laser beam enters, i.e. grows with increasing travelling distance of the laser beam in the glass. In the example the chippings 21 extend about 38 μm along the edge face 12.

However, with the laser parameters as explained above, in particular using laser pulses having a duration of less than 50 ps, preferably less than 20 ps, this effect can be largely or completely avoided. FIG. 13 shows a micrograph of an edge face 12, also taken at a part 32 with oblique interfaces 52, cleaved after filamentation with ultrashort laser pulses having a duration of 10 ps. Chippings are neither visible at the interfaces 52 nor at the edges to the main surfaces 30, 31.

Generally, the roughness of the edge face 12 can be influenced by the pitch between the filament shaped damages 19, the pulse energy, pulse duration and burst of the used ultra short laser source 15 as well as by the focal offset of the elongated focus 17. Thus, one or more of these parameters may also be varied along the contour. A varying roughness may even be targeted to adapt the edge toughness and/or the light reflecting characteristics of the edge face.

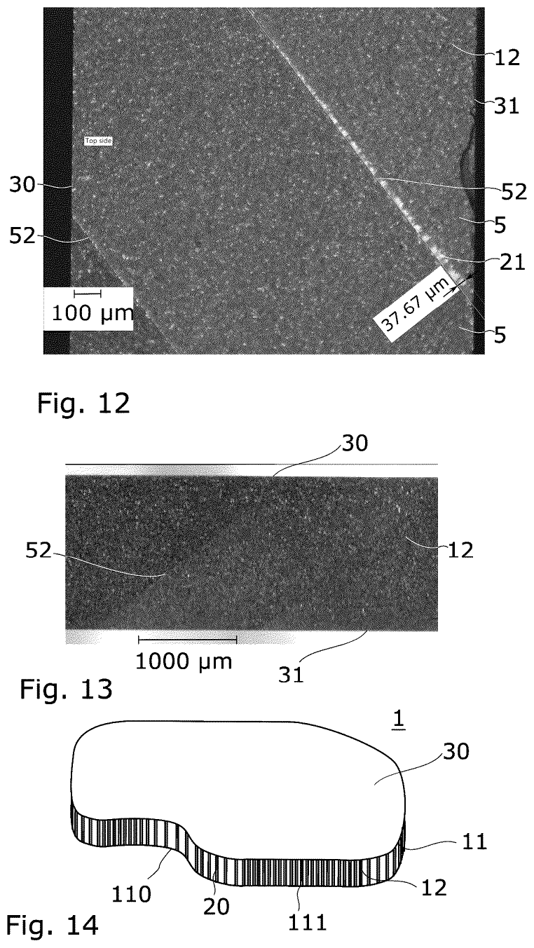

FIG. 14 schematically shows a reflective light guide device 1. For the sake of simplicity, the glass elements 5 and organic bond layers 7 are not shown. Generally and preferred, the contour 11 or edge face 12, respectively, of the reflective light guide device 1 has a varying curvature. This is also the case for the example shown in FIG. 4. In addition, the contour 11 or edge face 12 may even have inwardly curved or concavely curved section of contour 11, or edge face 12, respectively. Further, the contour 11 may comprise one or more sections with very low curvature, or even one or more straight sections 111, as shown.

The pitch of the filament shaped damages 19 or the resulting groove like structures 20 may be varied, which also can influence the roughness of the edge face 12. For example, a low roughness can be achieved with a small pitch. On the other hand, a bigger pitch may result in higher breaking forces required for cleaving. In the example, a larger pitch has been used for the sections with higher curvature, whereas a small pitch is used in the less curved sections, such as the straight section 111. This facilitates the cleavage in the highly curved and inwardly curved sections and results in a low roughness surface in the straight section 111. The pitch typically shows a local minimum for the cleaving force. If the pitch is too small, shadowing of the focused beam by existing filament curtain may occur. If the pitch is too big, the distance between filaments gets too big, resulting in a higher breaking force as well. In a pitch regime where shadowing is negligible, increasing the pitch typically lowers the surface roughness. Burst has bigger impact on surface roughness (higher burst, higher surface roughness, lower cleaving force). However, the pitch may be varied differently, depending on the structure and shape of the reflective light guide device 1 and the refractive index of the glass elements. For example, it may be advantageous to use a pitch along part 32 which is different from the pitch in adjacent parts due to reflections at the interfaces between the glass elements 5. Thus, generally, without restriction to the example as shown, in a refinement of the method and the resulting reflective light guide device 1 cleaved from the light guide plate 3, the pitch of the filament shaped damages 19, or the channel or groove like structures 20 is varied along contour 11 or edge face 12, in particular, depending on the curvature and functionality of the section. Similarly, as explained, the surface roughness may vary along the edge face 12, in particular, depending on the curvature.

If, on the other hand, the pitch is kept constant, the roughness proves to be nearly constant as well, even with varying curvature. The following table shows Sa values at measurement positions M1, M2, . . . . M5 along a contour within a part 32 with varying curvature and varying angle of the light reflecting layers 9 to the edge face. The roughness has been measured on four edge faces. Sample 1 was manufactured with the main surface 30 facing upwards resp. sample 2 with the main surface 31 facing upwards. The cutting along the predefined contour 11 was varied.

TABLE 1

| | | Sa (μm) | | | | | statistics | |
|---|---|---|---|---|---|---|---|---|
| | Cutting | measurement position | | | | | | std. |
| | direction | M1 | M2 | M3 | M4 | M5 | mean | dev. |
| sample 1 | Left-right | 0.60 | 0.68 | 0.64 | 0.62 | 0.64 | 0.64 | 0.03 |
| sample 1 | right-left | 0.67 | 0.60 | 0.67 | 0.61 | 0.57 | 0.62 | 0.05 |
| sample 2 | left-right | 0.72 | 0.65 | 0.66 | 0.63 | 0.62 | 0.66 | 0.04 |
| sample 2 | right-left | 0.59 | 0.57 | 0.63 | 0.74 | 0.66 | 0.64 | 0.07 |
| statistics | mean | 0.65 | 0.63 | 0.65 | 0.65 | 0.62 | | |
| | std. dev. | 0.06 | 0.05 | 0.02 | 0.06 | 0.04 | | |

As is evident, there is no major influence of the curvature or the orientation of the glass elements 5 to the resulting roughness. Also, the roughness at the top, where the laser beam enters is similar to the roughness near the edge to the other main surface, where the laser beam exits. Further, it is evident from the data that a surface roughness mean value of less than Sa=1.0 μm or even less than Sa=0.75 μm may be achieved even in a part 32 where the laser beam crosses interfaces between glass elements including an organic bond layer and a light reflecting layer 9.

TABLE 2

| | | Sa (μm) | | | | |
|---|---|---|---|---|---|---|
| | | | | | statistics | |
| sample | | measurement position | | | | std. |
| Part Number | Interface | M1 | M2 | M3 | mean | dev. |
| Sample 3 | T01.1 | 0.48 | 0.48 | 0.50 | 0.48 | 0.01 |
| Sample 4 | T01.2 | 0.52 | 0.55 | 0.58 | 0.55 | 0.03 |
| Sample 3 | T02.1 | 0.61 | 0.62 | 0.63 | 0.62 | 0.01 |
| Sample 5 | T02.2 | 0.66 | 0.64 | 0.63 | 0.64 | 0.01 |
| Sample 6 | T03 | 0.63 | 0.64 | 0.61 | 0.63 | 0.01 |
| Sample 5 | T03 | 0.65 | 0.67 | 0.66 | 0.66 | 0.01 |
| Sample 7 | T04 | 0.61 | 0.61 | 0.60 | 0.61 | 0.00 |
| Sample 6 | T04 | 0.74 | 0.75 | 0.73 | 0.74 | 0.01 |
| Sample 8 | T05 | 0.76 | 0.77 | 0.72 | 0.75 | 0.03 |
| Sample 7 | T05 | 0.77 | 0.77 | 0.78 | 0.77 | 0.01 |
| Sample 8 | T06 | 0.63 | 0.63 | 0.61 | 0.62 | 0.01 |
| statistics | mean | 0.64 | 0.65 | 0.64 | | |
| | std. dev. | 0.09 | 0.09 | 0.08 | | |

Table 2 shows the surface roughness SA along a contour within part 32 at measurement positions M1, M2, M3. The roughness has been measured on the interfaces T01, T02, . . . . T06 on both parts resulting from the cut. Each set of parameters results in one interface on two parts. It is evident from the data that the mean value of the surface roughness of the edge face 12 is controllable and can be changed deliberately along the predefined contour 11 by adapting the laser parameters locally.

Compared to CNC machining, the process according to this disclosure is faster and requires fever steps. A typical processing time for CNC machining and subsequent cleaning is about 6 minutes, involving different machines, which can be reduced to less than 3 minutes using the laser filamentation and cleaving according to this disclosure. Further, the laser process can be adapted to a clean room. Another advantage is the high accuracy regarding the alignment of the contour to the features such as the various light reflecting layers. It is difficult to obtain accuracies better than +55 μm using CNC machining. The following table contains deviations to the ideal contour in mm, achieved using the method according to this disclosure. The substrates used are test samples which do not have the same features as the reflective light guide device but can be used for calibration.

| | Glass 1 | Glass 1 | Glass 1 | Glass 2 | Glass 2 | Glass 2 |
|---|---|---|---|---|---|---|
| | sample 1 | sample 2 | sample 3 | sample 1 | sample 2 | sample 3 |
| refractive index n_{d} | 1.517 | 1.517 | 1.517 | 1.606 | 1.606 | 1.606 |
| datum lines | 0.026 | 0.030 | 0.032 | 0.027 | 0.027 | 0.028 |
| no base system | 0.026 | 0.026 | 0.030 | 0.021 | 0.025 | 0.026 |
| all fiducial marks | 0.032 | 0.040 | 0.035 | 0.029 | 0.031 | 0.028 |
| fiducial mark 1 | 0.027 | 0.027 | 0.031 | 0.024 | 0.026 | 0.025 |
| fiducial mark 2 | 0.029 | 0.028 | 0.033 | 0.027 | 0.028 | 0.027 |
| fiducial mark 3 | N/A | 0.031 | 0.036 | 0.031 | 0.032 | 0.030 |

The samples are made from glass 1 or glass 2. The deviations were measured with respect to datum lines connecting internal features (row designated “datum lines”), with respect to the ideal outer contour (row designated “no base system”) and with respect to three fiducial marks (lower four rows). As can be seen, the total deviations are 36 μm (corresponding to +−18 μm) or less. Thus, the accuracy is considerably higher compared to CNC machining. Generally, without restriction to the examples in the table, in one embodiment, the orientation and position of the contour of the reflective light guide device has an accuracy of better than +55 μm with respect to a reference point or datum line of the light guide device. This feature may also be verified by comparing the orientation and position of the contour to a reference point or datum line of a multitude of reflective light guide devices 1.

### LIST OF REFERENCE NUMERALS

| | |
|---|---|
| 1 | reflective light guide device |
| 2 | Eyepiece |
| 3 | light guide plate |
| 4 | support |
| 5 | glass element |
| 7 | organic bond layer |
| 8 | fiducial mark |
| 9 | light reflecting layer |
| 11 | predefined contour |
| 12 | edge face of light guide device 1 |
| 13 | laser beam |
| 15 | ultrashort pulse laser |
| 16 | lens |
| 17 | focus of laser beam 13 |
| 19 | filament shaped damage |
| 20 | elongated channel or groove like structures |
| 21 | chipping |
| 30, 31 | main surface of light guide plate 3 |
| 32, 36, 38, 40 | part of light guide plate 3, reflective light guide device 1 |
| 35 | edge between main surface 30, 31 and edge face 12 |
| 40 | vacuum pump |
| 41 | channel |
| 42 | clearance |
| 43 | support face |
| 50 | bond face of glass element 5 |
| 51 | face of glass element 5 |
| 52 | interface between cemented glass elements 5 |
| 110 | inwardly curved section of contour 11 or edge face 12 |
| 111 | straight section |
| 120 | edge between main surface 30, 31 and edge face 12 |

What is claimed is:

1. A method for cutting a reflective light guide device from a light guide plate,
the light guide plate having two main surfaces, and comprising a multitude of glass elements with bond faces, the glass elements being cemented together by bond layers at their bond faces,
the light guide plate further comprising light reflecting layers extending along the bond faces of the glass elements cemented together, wherein
within a part of the light guide plate, the bond faces of the glass elements and hence the light reflecting layers are oriented obliquely to the main surfaces, and wherein a reflective light guide device is cut from the light guide plate along a predefined contour by focusing and directing the laser beam of an ultrashort pulse laser onto the light guide plate so that the laser beam enters the light guide plate on one of the main surfaces and has an elongated focus so that a filament shaped damage is formed along the elongated focus within the light guide plate, and wherein
the laser beam is advanced relative to the light guide plate along the predefined contour so that a multitude of filament shaped damages are introduced side-by-side into the light guide plate so that the filament shaped damages are reproducing the predefined contour, wherein
a section of the predefined contour extends within the part of the light guide plate in which the cemented bond faces of the glass elements and the light reflecting layers are oriented obliquely to the main surfaces so that the laser beam penetrates the light reflecting layer being oriented obliquely to the laser beam, wherein the filament shaped damages extend on both sides of the light reflecting layer, and wherein
the reflective light guide device is separated from the light guide plate at the predefined contour weakened by the filament shaped damages by cleaving.

2. The method according to claim 1, wherein the light reflecting layers have a higher reflectance in the visible wavelength range between 750 nm and 450 nm compared to the wavelength of the laser beam, the wavelength of the laser beam being within an infrared wavelength range from 900 nm to 1200 nm.

3. The method according to claim 1, wherein a laser beam is used having a wavelength for which the reflectance at the interface between adjacent glass elements is less than 5%, the interface being formed by the bond faces of the glass elements with the intermediate bond layer and the light reflecting layer.

4. The method according to claim 1, wherein at least one of the following features is present:
the filament shaped damages are introduced with laser pulses having a pulse length of less than 50 ps;
the ultrashort pulse laser is operated in single pulse mode or in burst mode with less than eight pulses per burst;
the number of pulses per burst is varied along the contour;
the pulse energy of the ultrashort pulse laser is varied along the contour; or
the pitch of the filament shaped damages is varied along the contour.

5. The method according to claim 4, wherein the filament shaped damages are introduced with laser pulses having a pulse length of less than 20 ps.

6. The method according to claim 1, further comprising engraving one or more fiducial marks by ablation using the ultrashort pulse laser.

7. The method according to claim 1, wherein the following steps are executed:
a light guide plate is provided and fixed on a support,
the light guide plate fixed on the support is aligned relative to the ultrashort pulse laser based on a feature of the light guide plate, the feature selected from one of: the interface between two glass elements cemented together, a light reflecting layer, an edge of the light guide plate,
the light guide plate is moved relative to the ultrashort pulse laser until a predefined position for a fiducial mark is reached and the fiducial mark is introduced by ablation using the ultrashort pulse laser,
the light guide plate and the ultrashort pulse laser are moved relative to each other so that the laser beam moves along the predefined contour and introduces a series of filament shaped damages on the contour, and
the light guide plate is cleaved at the predefined contour weakened by the filament shaped damages so as to obtain the reflective light guide device.

8. The method according to claim 1, wherein the light guide plate is fixed onto a support that has a clearance extending along the predefined contour.

9. A reflective light guide device being plate shaped and having two main surfaces and an edge face forming the outer contour of the reflective light guide device and extending between the main surfaces, wherein the reflective light guide device
comprises a multitude of glass elements with bond faces, the glass element being cemented together by bond layers at their bond faces, and wherein
the reflective light guide device further comprises light reflecting layers extending along the bond faces, wherein
within a part of the reflective light guide device the bond faces of the glass elements and hence the light reflecting layers are oriented obliquely to the main surfaces, and wherein some of the light reflecting layers that are oriented obliquely to the main surfaces terminate at the edge face of the reflective light guide device, wherein the edge face has a surface structure with at least one of the following features:
the surface structure has an anisotropic spatial frequency spectrum, wherein the spatial frequencies in the direction vertically to the main surfaces have a lower median value than the spatial frequencies in a direction perpendicular thereto along the edge face,
the edge face has a pattern of regularly spaced elongated channel like structures extending perpendicular to the main surfaces having a lateral dimension of less than 2 μm.

10. The reflective light guide device according to claim 9, having at least one of the following features:
chippings at the edge between the edge face and a main surface within the part where the bond faces of the glass elements and hence the light reflecting layers are oriented obliquely to the main surfaces in average extend into the main surface by less than 30 μm,
chippings at the edge between the edge face and a main surface within the part of the reflective light guide where the bond faces of the glass elements and hence the light reflecting layers are oriented obliquely to the main surfaces in average extend along the edge face by less than 30 μm,
chippings at the edge between the edge face and a main surface having a length along the edge of less than 50 μm in average.

11. The reflective light guide device according to claim 9, wherein the edge face has a roughness with an arithmetical mean height value Sa of less than 1.5 μm.

12. The reflective light guide device according to claim 9, wherein the edge face has a varying curvature.

13. The reflective light guide device according to claim 9, wherein the edge face has an inwardly curved section.

14. The reflective light guide device according to claim 9, wherein the pitch of the elongated channel like structures or the surface roughness varies along the edge face of the reflective light guide device.

15. The reflective light guide device according to claim 9, wherein the reflective light guide device forms an eyepiece.
